(19) United States
(12) Patent Application Publication
(10) Pub. No.: US 2026/0063218 A1
(43) Pub. Date: Mar. 5, 2026

(54) ELECTRICALLY CONTROLLED THROTTLE VALVE

(71) Applicant: HUSQVARNA AB, Huskvarna (SE)

(72) Inventor: Martin LINDEKULL, Huskvarna (SE)

(21) Appl. No.: 19/320,214

(22) Filed: Sep. 5, 2025

(30) Foreign Application Priority Data
Sep. 5, 2024 (SE) 2450884-8

(51) Int. Cl. F16K 31/05; F02B 75/02; F02D 9/10; F16K 31/52

(52) U.S. Cl. CPC F16K 31/055; F02B 75/02; F02D 9/1065; F16K 31/521; F02B 2075/025

(57) ABSTRACT

A throttle valve arrangement for a handheld power tool, the throttle valve arrangement comprising a valve plate attached to a valve shaft, the valve shaft being arranged to rotate about a valve shaft axis from an idle throttle position to a wide open throttle, WOT, position, wherein the rotation of the valve shaft about the valve shaft axis is arranged to be biased towards a configurable valve shaft angle by a first actuator, wherein a second actuator of the throttle arrangement is arranged to resist rotation of the valve shaft about the valve shaft axis towards the WOT position, past an angle determined by a state of the second actuator.

### TECHNICAL FIELD

The present disclosure relates to throttle arrangements for two-stroke combustion engines of the type used in handheld power tools such as power cutters and Chainsaws. The throttle arrangements are controlled in part by an automated electrically operated actuator.

### BACKGROUND

Chainsaws are handheld power tools designed for cutting wood and other materials by a cutting chain that is supported on a guide bar in a known manner. Chainsaws can be powered by two-stroke combustion engines.

Power cutters are handheld power tools designed for cutting hard materials such as concrete and stone by a rotatable abrasive cutting disc. Power cutters are also often driven by two-stroke combustion engines.

It is normally desired to restrict the speed of the combustion engine to speeds below a maximum speed, e.g., in order to reduce engine wear and emissions. Cut-out is a method that is commonly applied for limiting two-stroke engine speed. In ignition cut-out the ignition of the engine is selectively inactivated, while in fuel cut-out the fuel supply is regulated to reduce engine speed.

Ignition cut-out is commonly used in handheld power tools even though it is associated with drawbacks such as increased emission and undesired vibrations.

Swedish national patent application SE2251418A1 relates to methods for restricting the rotational speed of a crankshaft of an engine of a handheld power tool.

There is a desire for alternative methods of controlling two-stroke combustion engine speed in handheld power tools.

### SUMMARY

It is an objective of the present disclosure to provide improved two-stroke combustion engines. This objective is at least in part obtained by a throttle valve arrangement for a handheld power tool. The throttle valve arrangement comprises a valve plate attached to a valve shaft. The valve shaft is arranged to rotate about a valve shaft axis from an idle throttle position to a wide open throttle (WOT) position. The rotation of the valve shaft about the valve shaft axis is arranged to be biased towards a configurable valve shaft angle by a first actuator. A second actuator of the throttle arrangement is arranged to resist rotation of the valve shaft about the valve shaft axis towards the WOT position, past an angle determined by a state of the second actuator. This way both actuators are able to influence the state of the valve plate. The first actuator is always able to reduce throttle by adjusting the configurable angle towards idle throttle position, while the second actuator controls the state of the valve plate from the idle throttle position up to the configurable angle.

According to a preferred embodiment, the first actuator comprises an automated electrically operated actuator and the second actuator comprises a manually operated actuator. The throttle valve arrangement allows for automated restriction of the throttle valve state by the automated electrically operated actuator, while at the same time allowing for manual control of the throttle state by the manually operated actuator. This throttle valve arrangement can therefore be used for automated engine speed restriction, without ignition cut-out, which is an advantage.

According to some aspects, the first actuator comprises a first actuator member that is arranged to engage a first torsion spring. The first torsion spring is configured to apply a biasing torque to a first shaft lever attached to the valve shaft. The biasing torque of the first torsion spring is directed towards the configurable valve shaft angle. This way a robust implementation of the first actuator is obtained. The first shaft lever and the first actuator member can, for instance, be arranged at least in part inbetween first and second legs of the first torsion spring to respectively engage at least one of the first and second legs.

The first actuator can also comprise an electric rotary actuator attached in torque transmitting relation to the valve shaft to apply the biasing torque, or an electric linear actuator attached in torque transmitting relation to the valve shaft via a lever to apply the biasing torque. These actuators can be used instead of the first torsion spring, or in addition to the first torsion spring to generate the biasing torque.

According to some aspects, the second actuator comprises a second actuator member that is arranged to rotate about the valve shaft axis relative to the valve shaft and to engage a second shaft lever that is attached to the valve shaft, to resist the rotation of the valve shaft towards the WOT position. A second torsion spring is arranged to urge rotation of the second actuator member towards engagement with the second shaft lever, wherein the second actuator member is configured to be rotated away from the second shaft lever by a mechanical connection to a manual throttle control device of the handheld power tool. This way a robust implementation of the second actuator is obtained.

The throttle valve arrangement optionally comprises a first stop and a second stop that are arranged to limit movement of the first actuator to within a predetermined movement range. This predetermined movement range restricts operation of the valve arrangement to within a desired operating range, which is an advantage. The predetermined movement range is also known a-priori and can therefore be used to calibrate the different parts of the throttle valve arrangement, such as any automated electric actuators of the valve arrangement.

The valve plate of the throttle valve arrangement is preferably arranged in a valve housing which at least partly defines an air intake channel of the throttle valve arrangement. The valve housing also supports the valve shaft and the first actuator. The valve housing forms part of a throttle valve arrangement module which can be assembled in an efficient manner with other parts of the combustion engine and/or other parts of the tool driven by the combustion engine.

According to some aspects, the throttle valve arrangement also comprises a control unit arranged to control a state of the first actuator. The control unit is arranged to configure an upper limit of a throttle span of the throttle valve arrangement to lie between idle and WOT by control of the first actuator. The control unit can for instance be arranged to obtain data related to an engine speed of the handheld power tool and to reduce the upper limit of the throttle span in case the engine speed exceeds a predetermined maximum engine speed. The control unit can also be arranged to determine a state of the first actuator during a start-up procedure and/or during a shut-down procedure of the control unit, in order to calibrate operations of the throttle valve arrangement.

Methods, control units, and handheld power tools comprising the throttle valve arrangements are also disclosed herein.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIGS. 1A-B illustrate example power tools;

FIG. 2 schematically illustrates a throttle valve arrangement;

FIG. 3 is a graph illustrating throttle state;

FIG. 4 illustrates a throttle valve control principle based on rotation bias;

FIGS. 5 and 6A-B show an example throttle valve arrangement;

FIGS. 7A-B, 8A-B and 9A-B show a valve arrangement in different states;

FIG. 10 is a flow chart that illustrates methods;

FIG. 11 shows an example control unit comprising processing circuitry; and

FIGS. 12-13 illustrate examples of electrically operated actuators.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

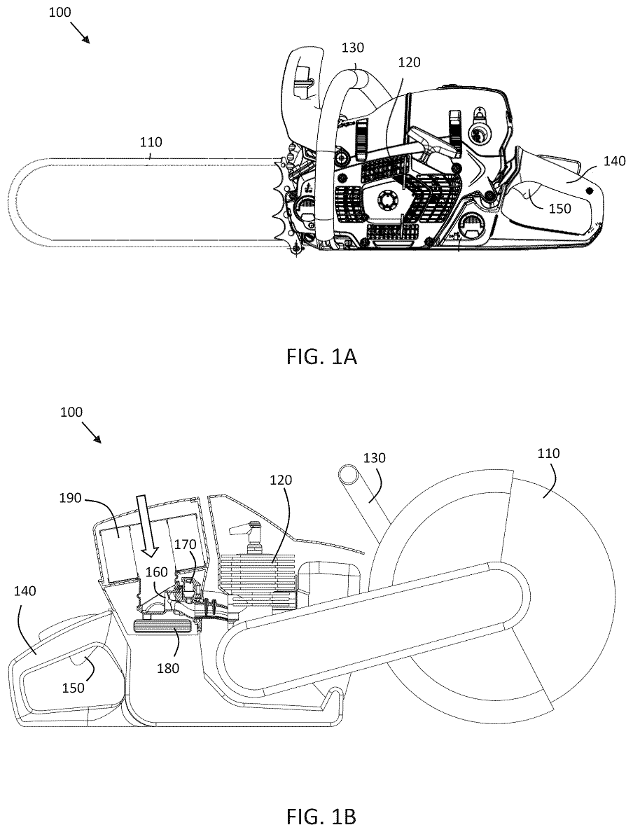

FIGS. 1A-B show example combustion engine driven handheld power tools 100. FIG. 1A shows a chainsaw and FIG. 1B shows a power cutter. The chainsaw comprises an active part 110 in the form of a saw chain supported on a guide bar. An abrasive saw blade for cutting hard materials such as concrete and stone constitutes the active part 110 of the power cutter.

Chainsaws and power cutters are examples of handheld power tools in which the techniques discussed herein can be applied. The present disclosure is, however, not limited to the examples in FIGS. 1A-B but can be generally applied in many different types of handheld power tools, such as hedge trimmers, clearing saws, leaf blowers, lawn mowers, and the like.

The example power tools in FIGS. 1A-B both comprise a front handle 130 that extends transversally over the main body of the tool and a rear handle 140 located at an opposite distal end of the power tool compared to the active part 110. The front handle 130 is closer to the active part 110 compared to the rear handle 140. The techniques disclosed herein can also be used with machines having other types of handle configurations, such as top-handle machines and machines with a single handle.

The rear handle 140 comprises a manual trigger 150 which is used by an operator to control the operation of the power tool in a known manner. The trigger 150 optionally comprises a lock-out mechanism 155 which if present must be released before the trigger 150 can be depressed by the operator. A throttle cable or wire can be attached to the trigger and guided to a spring loaded throttle valve in order to control the state of the throttle valve.

A throttle lever can be used instead of a trigger on some machine types. The throttle lever is often connected to a spring loaded valve of a throttle valve arrangement on the machine.

The power tools 100 considered herein comprise a two-stroke combustion engine 120 arranged to drive the active part 110. The present disclosure is not limited to petrol combustion but can be applied also in other types of combustion engines comprising throttle valve arrangements.

The two-stroke engine 120 is normally a crankcase scavenged two-stroke engine, although other types of two-stroke engines are also possible. The engine 120 comprises an air intake which is regulated by a throttle valve arrangement. An example throttle valve arrangement 160 can be seen in FIG. 1B which shows a cross-section view.

The throttle valve 160 may be configured to regulate a flow of clean air into the combustion engine or to regulate a fuel and air mixture flow. It is also possible that the throttle valve arrangement regulates both a fuel and air mixture flow and a clean air flow at the same time, e.g., in case the combustion engine implements an airhead system. The throttle valve 160 normally opens up to accelerate the combustion engine 120 when the trigger 150 is depressed and restricts the air flow into the engine 120 to slow down the engine when the trigger is released.

The air flow into the combustion engine 120 passes via an air filter 190, as indicated by the arrow in FIG. 1B.

The example power tool in FIG. 1B shows a design based on low pressure fuel injection wherein a fuel injector 170 provides fuel to the input air intake regulated by the throttle valve. Carburettor based designs are also possible, as well as high-pressure fuel injection systems which inject fuel directly into the cylinder of the combustion engine 120.

The throttle valve arrangements disclosed herein are at least partly controlled by an electronic control unit via some form of electrically operated actuator. An example control unit 180 can be seen in the cross-section view in FIG. 1B. Electronic control units will be discussed in more detail below, for instance in connection to FIG. 11.

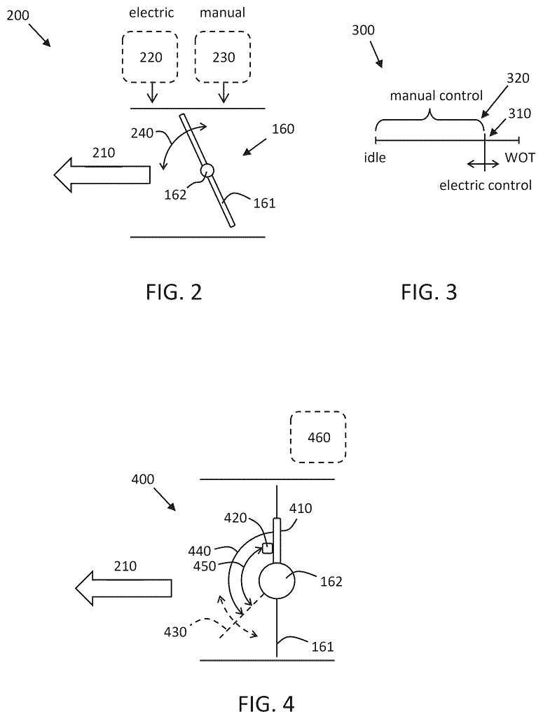

FIG. 2 schematically illustrates a throttle valve arrangement 200 arranged to regulate an air flow 210 into the combustion engine 120 of a handheld power tool 100 such as a chainsaw or a power cutter. The throttle valve arrangement comprises a valve plate 161 attached to a valve shaft 162. As the shaft is rotated 240 back and forth about its axis of rotation, the valve plate 161 either obstructs the air intake channel or opens it up. A position wherein the air intake channel is fully obstructed is referred to herein as an idle throttle position while a fully open air channel position is referred to as a wide open throttle (WOT) position. It is appreciated that a small amount of air normally passes via the valve in the idle position to maintain an idling operation by the combustion engine.

The throttle valve arrangements discussed herein comprise a first actuator 220 and a second actuator 230 that are arranged to engage the valve shaft 162 to jointly control the state of the single valve plate 161. The first actuator 220 comprises an electrically operated actuator and the second actuator 230 comprises a manually operated actuator. The first actuator 220 is an automatic actuator in the sense that it is automatically controlled by an electronic control unit implementing a control algorithm, such as the control unit 180. The second actuator is a manual actuator in the sense that its state is governed by the state of a manual throttle control device of the handheld power tool 100, such as the trigger 150 discussed above or a throttle control lever.

The combination of the first actuator 220 and the second actuator 230 operating on the same valve plate axle and the same valve plate allow for a hybrid throttle control system wherein manual control of the throttle via, e.g., a trigger or lever is allowed and also automated control of the throttle via an electric actuator controlled by an electronic control unit.

WO 2020/027711 A1 describes a throttle valve arrangement capable of a similar type of hybrid manual/electric control of a two-stroke combustion engine. The throttle valve arrangements discussed herein can be used for applications similar to those discussed in WO 2020/027711 A1.

FIG. 3 is a graph that illustrates how the first actuator 220 and the second actuator 230 can be used to jointly control the state of the valve plate 161 in a throttle valve arrangement. The valve plate 161 can rotate 240 between an idle position wherein the air flow 210 is severely restricted to WOT wherein a high air flow is allowed. The first actuator 220 is used to configure an upper limit 310 of a throttle span 320 of the second actuator 230. This means that the second actuator 230, i.e., the manual actuator, can be used to adjust the state of the valve plate 161 freely within a throttle span having an upper limit governed by the electronic control unit 180 via the first actuator 220. The first actuator can always reduce the throttle air flow by decreasing the upper limit 310 of the throttle span 320. However, the first actuator 220 cannot increase throttle air flow above the throttle level of the second actuator 230.

The arrangement provides several advantageous technical features. For instance, the first actuator 220 can be used to implement efficient automatic engine speed restriction to replace or complement legacy cut-out methods, since it governs the upper limit 310 of the throttle span 320. The control unit 180, having obtained data related to a speed of the engine from some sort of speed sensor, can restrict the speed by operating the first actuator 220 in an automated manner. The manual actuator 230 also governs the speed of the engine in the sense that the manual actuator can always be used to reduce the speed of the engine, e.g., to bring the engine into idle speed operation, regardless of the state of the first actuator 220. This safety feature guarantees that the engine speed can be brought down to idle speed in case the first actuator 220 malfunctions.

The engine speed can be obtained from a speed sensor such as a Hall effect sensor or the like in a known manner. Engine speed can also be deduced from ignition timing in a known manner.

FIG. 4 schematically illustrates an example technical implementation 400 of a throttle valve arrangement having the features discussed above. A lever 410 is fixed to the valve shaft 162, such that it rotates together with the valve plate 161. The rotation of the valve shaft 162 about the valve shaft axis is arranged to be biased 440 towards the WOT position of the valve plate 161 at least in part by a first actuator 460, such as a torsion spring arrangement, an electric actuator operating on the valve shaft 162, or some other biasing member. A manually operated actuator 420 resists rotation of the valve shaft 162 towards WOT. Thus, the valve arrangement only opens up if the manual actuator is operated to allow rotation 440 of the shaft 162 counter-clockwise in FIG. 4. The first actuator 460 is configured to apply the biasing torque to the valve shaft 162 towards a configurable valve shaft angle 430. In other words, the first actuator 460 will try to rotate the shaft 162 to the configurable valve shaft angle 430 but not beyond. This configurable valve shaft angle 430 corresponds to the upper limit 310 of the throttle span 320. Manual control of the throttle valve state from idle to the upper limit 310 of the throttle span 320 is effected by moving the manual actuator 420 along the arc 450. Moving the manual actuator along the arc 450 permits the shaft to rotate a corresponding distance, since there is no longer any resistance to the biasing force applied by the first actuator 460. The shaft 162 will, however, not rotate past the configurable valve shaft angle 430 regardless of the position of the manual actuator 420, since the first actuator applies a biasing torque directed towards this configurable valve shaft angle 430.

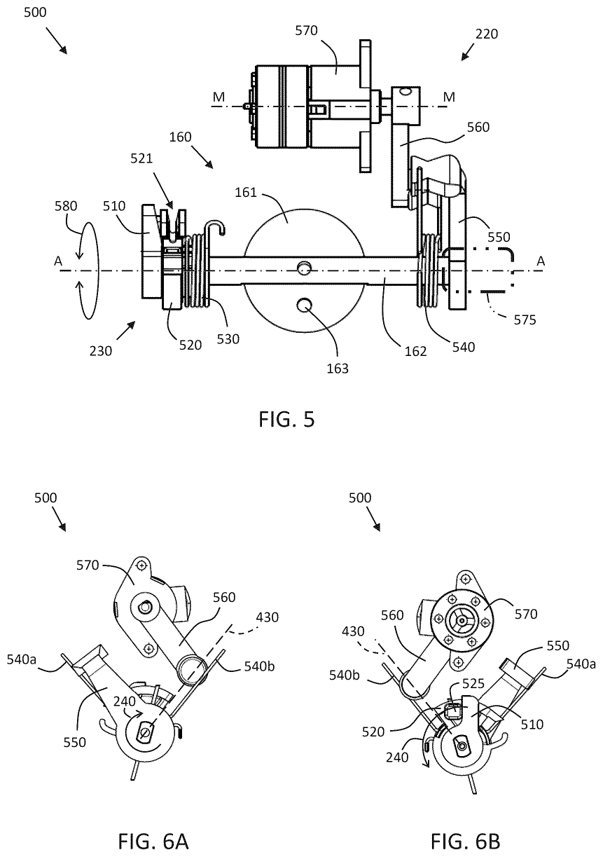

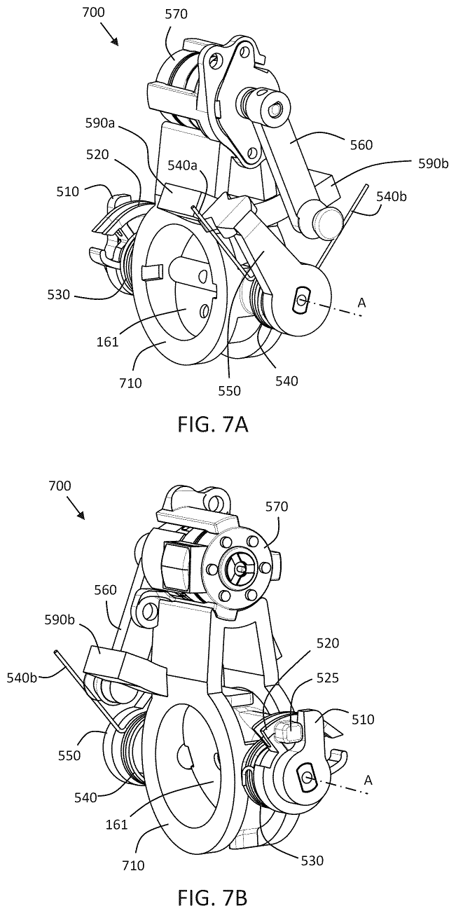

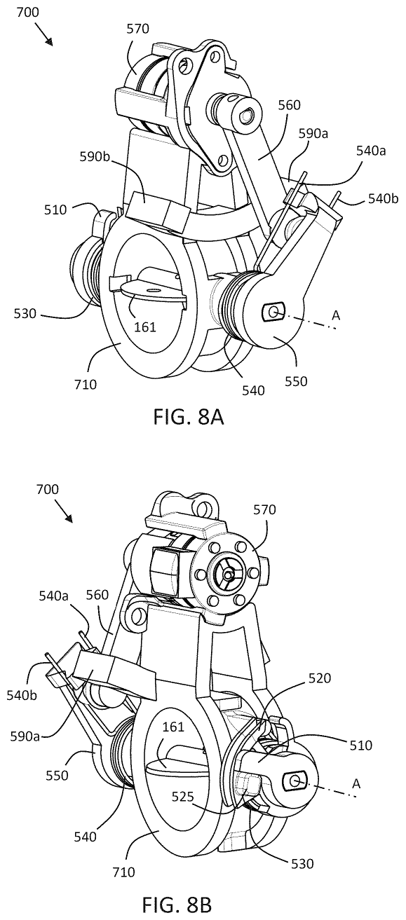

More detailed implementation examples of this throttle valve control principle will be given below in connection to FIG. 5, FIGS. 6A-B, FIGS. 7A-B, FIGS. 8A-B, FIGS. 9A-B, and FIGS. 12-13.

To summarize, there is disclosed herein a throttle valve arrangement 160, 200, 500, 700 for a handheld power tool 100 such as a chainsaw or a power cutter.

The throttle valve arrangement comprises a valve plate 161 attached to a valve shaft 162. The valve shaft 162 is arranged to rotate about a valve shaft axis A from an idle throttle position to a WOT position. The rotation of the valve shaft 162 about the valve shaft axis A is arranged to be biased 440 towards a configurable valve shaft angle 430 by a first actuator 220, 560, 570, 575. A second actuator 150, 230, 420, 520 of the throttle arrangement 160, 200, 500, 700 is arranged to resist rotation 240 of the valve shaft 162 about the valve shaft axis A towards the WOT position, past an angle determined by a state of the second actuator 150, 230, 420, 520.

Normally, the throttle valve on a handheld power tool is spring loaded or otherwise biased towards its idle position. A common implementation involves a trigger or throttle lever that operates a throttle wire which is connected to the valve shaft in order to overcome the bias towards idle in order to open up the throttle and accelerate the combustion engine. Thus, when the trigger 150 is depressed, tension is applied to the throttle wire which tension overcomes the bias applied on the valve shaft to open up the throttle valve. At least some of the techniques disclosed herein adopts a different throttle valve control principle wherein the valve plate 161 is instead biased towards an open throttle state determined by the configurable valve shaft angle 430. This open throttle state is normally at WOT or close to WOT. The trigger 150 instead resists rotation of the valve plate 161 towards open throttle instead of urging rotation of the valve shaft towards idle.

FIG. 5 and FIGS. 6A-B illustrates an example implementation wherein an electric rotary actuator 570 is used to apply the rotation bias to the valve shaft 162 via an arrangement of levers 550, 560 and a torsion spring 540 with legs 540am 540b. FIG. 5 shows a view from the front of the valve plate 161, while FIGS. 6A-B show side views of the same implementation.

The example implementation in FIG. 5 and in FIGS. 6A-B is based on torsions springs 530, 540 and shaft levers 510, 550 attached to the valve shaft 162 to obtain the desired function. The electric actuator 570 controls the first actuator member 560 which is positioned inbetween the legs 540a, 540b of the torsion spring 540 to engage the legs. When the first actuator member 560 is rotated it swings to engage the torsion spring 540 which in turn applies a force to the shaft lever 550 and thus a rotation bias to the shaft 162 against the configurable valve shaft angle 430. If nothing prevents the shaft from rotating 580, then the electric actuator 570 controls the angle of the shaft 162 freely. However, the manual actuator 520 and the lever 510 will resist rotation of the shaft 162 towards WOT.

A throttle wire can be attached to the second actuator member 520 in a known manner and wound at least part of its circumference to allow torque transmission to the second actuator member 520. The throttle wire is guided by the V-shaped support 521 shown, e.g., in FIG. 5.

It is appreciated that an electric rotary actuator 575 can just as well be directly connected to the valve shaft 162 in order to apply the rotation bias towards the configurable valve shaft angle 430, as schematically illustrated in FIG. 5 and also in FIG. 12. In this alternative implementation the control unit 180 would obtain data indicative of a current rotation angle of the valve shaft 162, e.g., from a rotary encoder or the like. The control unit would then compare the current rotation angle of the shaft to the configurable valve shaft angle 430 and apply a predetermined amount of torque to the shaft to urge the shaft to rotate towards the configurable valve shaft angle 430. The predetermined amount of torque should be large enough to rotate the shaft 162 but not larger than the resisting force applied by the manual actuator.

The torque applied by an electric machine such as a servo motor or a linear actuator is a function of the current consumption of the electric machine. Relationships between current consumption and applied torque can be obtained, e.g., by practical experimentation or by mathematical analysis and used by the control unit 180 to control the first actuator 220. It is also possible to arrange a torque sensor at the output of the electric actuator, or at the valve shaft, in order to directly measure the applied biasing torque. Techniques for determining and controlling applied torque by an electric rotary actuator such as a servo motor are well known in the art and will therefore not be discussed in more detail herein.

FIG. 13 shows another alternative implementation wherein a linear actuator 576 is connected to the valve shaft 162 via a jointed rod in torque transmitting relation. Linear actuation by the actuator 576 can be controlled by the control unit 180. The force applied by the linear actuator generates the biasing torque discussed above.

Returning to the example illustrated in FIGS. 5 and 6A-B, the manual actuator 520 is spring loaded by the torsion spring 530 and able to rotate relative to the valve shaft. The torsion spring 530 urges the manual actuator 520 to rotate into abutment with the shaft lever 510 on the left in FIG. 5. This abutment is perhaps best seen in FIG. 6B, wherein a protruding heel 525 of the manual actuator 520 engages the lever 510 to resist rotation 240. Thus, the shaft 162 is urged by the torsion spring 540 to rotate 240 towards the configurable shaft angle 430 but is prevented from doing so by the manual actuator 520, which state is in turn normally governed by the position of the trigger 150, at least if the throttle valve arrangement is used on a power cutter or a chainsaw.

Note that the shaft 162 will not rotate past the configurable shaft angle 430, since the rotation bias will cease at this shaft angle. Consequently, the electric actuator 570 is able to limit the throttle span by adjusting the position of the first actuator member 560, i.e., the electrically operated member.

To summarize, an example implementation of the techniques disclosed herein is based on a throttle valve arrangement with a valve shaft 162 that comprises one or more shaft levers 510, 550 attached to the valve shaft 162. The first actuator 220 comprises an automated electrically operated actuator 570, 575, 576 and the second actuator 230 comprises a manually operated actuator 150. The first actuator 220, 560, 570 may, e.g., comprise a first actuator member 560 arranged to engage a first torsion spring 540 configured to apply a biasing torque to a first shaft lever 550 attached to the valve shaft 162, wherein the biasing torque of the first torsion spring 540 is directed towards the configurable valve shaft angle 430. The first shaft lever 550 and the first actuator member 560 are preferably arranged at least in part inbetween first and second legs 540a, 540b of the first torsion spring 540 to respectively engage at least one of the first and second legs 540a, 540b.

The first actuator 575 may also comprise an electric rotary actuator 575 attached directly or indirectly to the valve shaft 162 to apply the biasing torque, or an electric linear actuator 576 attached to the valve shaft 162 via a lever to apply the biasing torque. A transmission having a gear ratio may be used inbetween the electric actuators and the valve shaft in order to adjust a gear ration between the output of the electric actuator and the valve shaft.

The second actuator 230, 420, 520 optionally comprises a second actuator member 520 arranged to rotate about the valve shaft axis A relative to the valve shaft 162 and to engage a second shaft lever 510 attached to the valve shaft 162, to resist the rotation 240 of the valve shaft 162 towards the WOT position, as illustrated in the drawings. A second torsion spring 530 can be arranged to urge rotation of the second actuator member 520 towards engagement with the second shaft lever 510, wherein the second actuator member 520 is configured to be rotated away from the second shaft lever 510 by a mechanical connection to a manual throttle control device 150 of the handheld power tool 100, such as a throttle wire or some other type of transmission. A throttle lever or the like can of course be used instead of a trigger.

FIGS. 7A-B, 8A-B and 9A-B shows an example valve arrangement supported in a housing 710. According to this example the valve plate 161 is arranged in a valve housing 710 which at least partly defines an air intake channel of the throttle valve arrangement. The valve housing 710 furthermore supports the valve shaft 162 and also an example electric actuator 570 that is arranged to control the first actuator member 560. The throttle valve arrangement together with the electric actuator 570 forms a module which can be manufactured separately and assembled with the power tool 100 as a single unit, which is an advantage.

As noted above, the electric actuator 570 may comprise an electric rotary actuator or an electric linear actuator, or a combination of a linear and rotary actuator. Both rotary and linear actuators are well known in the art. Actuators which report applied torque are also well known and will therefore not be discussed in more detail herein. The state of the actuator, such as a servo motor governing the angular swing position of the arm 560, can be determined in a number of ways, e.g., by always entering into a known state such as the arm angle corresponding to idle or WOT when the power tool is shut down, by using a rotary encoder or the like to determine the swing position of the arm 560, or by storing the swing position of the arm 560 in persistent memory accessible from the control unit 180 when the power tool 100 is powered down.

The throttle valve arrangement 160, 200, 500, 700 may comprise a first stop 590a and a second stop 590b arranged to limit movement of the first actuator 220, 560, 570, 575 to within a predetermined movement range. These stops ensure that the first actuator 220, 560, 570, 575 does not deviate from its intended movement range, and can also be used for calibration purposes, i.e., to deduce the current state of the first actuator 220, 560, 570, 575. This can be done, for instance by forcing the first actuator member against a stop. When the member abuts the stop the current consumption of the electric actuator will go up, allowing the control unit 180 to detect that the member has reached the end of its allowed movement span.

The control unit 180 can, generally, be arranged to determine a state of the first actuator member 560, such as its angle relative to the shaft lever 550 or the valve shaft rotation angle during a start-up procedure and/or during a shut-down procedure of the power tool 100. The control unit 180 can also be configured to trigger a calibration routine comprising, e.g., moving the first actuator member 560 between the first stop 590a and the second stop 590b.

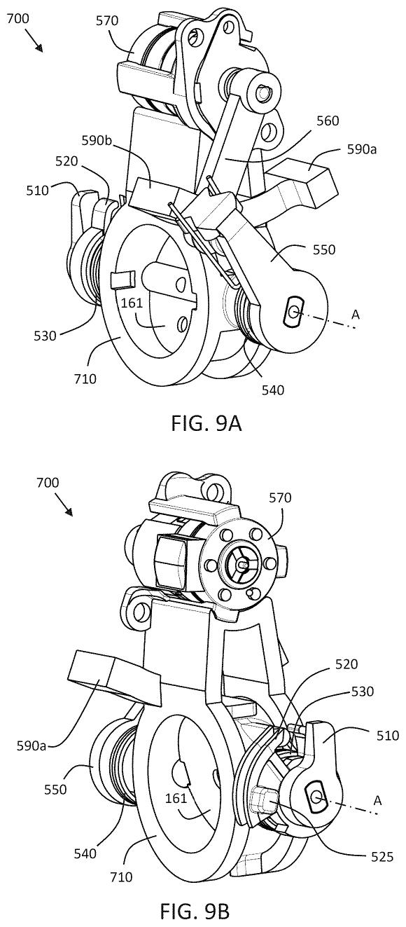

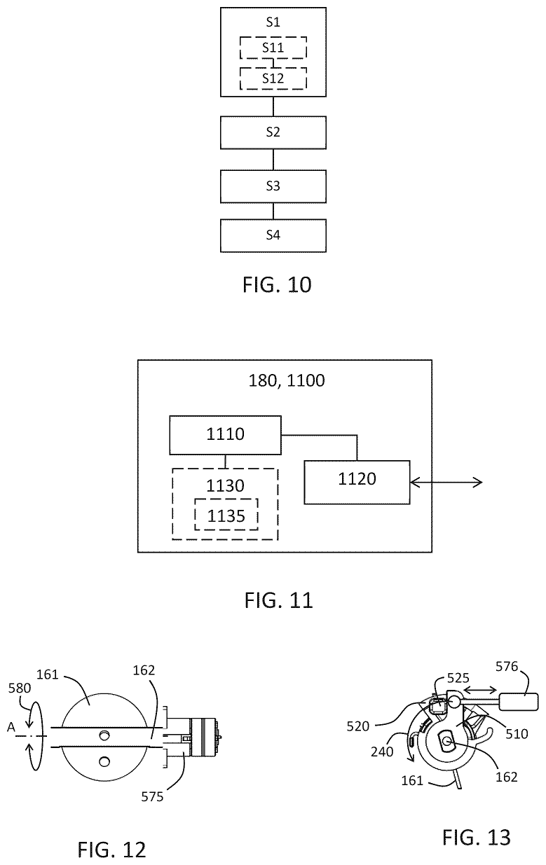

FIG. 10 is a flow chart that illustrates methods which summarize the different throttle valve control operations discussed above. FIG. 10 shows a method for controlling a throttle valve arrangement 160, 200, 500, 700 of a handheld power tool 100. The throttle valve arrangement 160, 200, 500, 700 comprising a valve plate 161 attached to a valve shaft 162, as well as a first actuator 220 and a second actuator 230 arranged to engage the valve shaft 162 and to jointly control the state of the valve plate 161. The method comprises
configuring S1 the first actuator 220 to limit a throttle span 320 of the throttle valve arrangement 160, 200, 500, 700 to an upper limit 310 that lies between idle and WOT,
configuring S2 the second actuator 220 to govern a state of the valve plate 161 over the throttle span 320,
obtaining S3, by a control unit 180 of the handheld power tool 100, data related to an engine speed of the handheld power tool 100, and
reducing S4 the upper limit 310 of the throttle span 320 in case the engine speed exceeds a desired maximum engine speed.

According to some aspects, the method also comprises urging S11 the state of the valve plate 161 towards a configurable valve shaft angle 430 between idle and WOT by the second actuator 220.

According to some aspects, the method comprises determining S12 a state of the first actuator 220, by the control unit 180, during a start-up procedure and/or during a shut-down procedure of the control unit 180. The state of the first actuator may, e.g., comprise the angle of the output axle of the electric rotary actuator 570, 575 or the extension length of the linear actuator 576. The state of the first actuator may also comprise the swing angle of the first actuator member 560. The state of the first actuator 220 may be determined by forcing the actuator to an endpoint of its movement range, which can for instance be limited by the stops 590a, 590b. The state of the first actuator 220 may also be determined by using one or more sensors, such as a rotary encoder or a position sensor.

According to an example, the control unit 180 is configured to place the first actuator 220 in a known state prior to shutting down. This way the state of the first actuator 220 is known when the control unit 180 and the other components of the handheld power tool 100 is powered up from a powerless state.

FIG. 11 schematically illustrates, in terms of a number of functional units, the general components of an electronic control unit 180, 1100. Processing circuitry 1110 is provided using any combination of one or more of a suitable central processing unit CPU, multiprocessor, microcontroller, digital signal processor DSP, etc., capable of executing software instructions stored in a computer program product, e.g., in the form of a storage medium 1130. The processing circuitry 1110 may further be provided as at least one application specific integrated circuit ASIC, or field programmable gate array FPGA.

Particularly, the processing circuitry 1110 is configured to cause the control unit 180 to perform a set of operations, or steps, such as the methods discussed herein. For example, the storage medium 1130 may store the set of operations, and the processing circuitry 1110 may be configured to retrieve the set of operations from the storage medium 1130 to cause the device to perform the set of operations. The set of operations may be provided as a set of executable instructions. Thus, the processing circuitry 1110 is thereby arranged to execute methods as herein disclosed.

The storage medium 1130 may also comprise persistent storage, which, for example, can be any single one or combination of magnetic memory, optical memory, solid state memory or even remotely mounted memory. The persistent storage may be configured to persistently store a state of the first actuator member 560 discussed above, and/or the state of an electric actuator 570, 575 such as a servo motor or other rotary actuator, or a linear actuator 576. This allows the control unit to remember the state of the first actuator 220 inbetween shut-down and power-up of the handheld power tool 100.

The device 180, 1100 may further comprise an interface 1120 for communications with at least one external device, such as a wheel speed sensor 810 or a load sensor 820. As such the interface 1120 may comprise one or more transmitters and receivers, comprising analogue and digital components and a suitable number of ports for wireline or wireless communication.

The processing circuitry 1110 controls the general operation of the control unit 180, 1100, e.g., by sending data and control signals to the interface 1120 and the storage medium 1130, by receiving data and reports from the interface 1120, and by retrieving data and instructions from the storage medium 1130.

There is also disclosed herein a computer readable medium carrying a computer program comprising program code means for performing the methods discussed herein, when said program product is run on a computer. The computer readable medium and the code means may together form a computer program product.

1. A throttle valve arrangement for a handheld power tool,
the throttle valve arrangement comprising a valve plate attached to a valve shaft, the valve shaft being arranged to rotate about a valve shaft axis from an idle throttle position to a wide open throttle (WOT) position,
wherein the rotation of the valve shaft about the valve shaft axis is arranged to be biased towards a configurable valve shaft angle by a first actuator,
wherein a second actuator of the throttle arrangement is arranged to resist rotation of the valve shaft about the valve shaft axis towards the WOT position, past an angle determined by a state of the second actuator.

2. The throttle valve arrangement according to claim 1, wherein the first actuator comprises an automated electrically operated actuator and the second actuator comprises a manually operated actuator.

3. The throttle valve arrangement according to claim 1, wherein the first actuator comprises a first actuator member arranged to engage a first torsion spring configured to apply a biasing torque to a first shaft lever attached to the valve shaft, wherein the biasing torque of the first torsion spring is directed towards the configurable valve shaft angle.

4. The throttle valve arrangement according to claim 3, wherein the first shaft lever and the first actuator member are arranged at least in part in between first and second legs of the first torsion spring to respectively engage at least one of the first and second legs.

5. The throttle valve arrangement according to claim 1, wherein the first actuator comprises an electric rotary actuator attached in torque transmitting relation to the valve shaft to apply the biasing torque, or an electric linear actuator attached in torque transmitting relation to the valve shaft via a lever to apply the biasing torque.

6. The throttle valve arrangement according to claim 1, wherein the second actuator comprises a second actuator member arranged to rotate about the valve shaft axis relative to the valve shaft and to engage a second shaft lever attached to the valve shaft, to resist the rotation of the valve shaft towards the WOT position,
wherein a second torsion spring is arranged to urge rotation of the second actuator member towards engagement with the second shaft lever, wherein the second actuator member is configured to be rotated away from the second shaft lever by a mechanical connection to a manual throttle control device of the handheld power tool.

7. The throttle valve arrangement according to claim 1, comprising a first stop and a second stop arranged to limit movement of the first actuator to within a predetermined movement range.

8. The throttle valve arrangement according to claim 1, wherein the valve plate is arranged in a valve housing which at least partly defines an air intake channel of the throttle valve arrangement, the valve housing supporting the valve shaft and the first actuator.

9. The throttle valve arrangement according to claim 1, comprising a control unit arranged to control a state of the first actuator, wherein the control unit is arranged to configure an upper limit of a throttle span of the throttle valve arrangement to lie between idle and WOT by control of the first actuator.

10. The throttle valve arrangement according to claim 9, wherein the control unit is arranged to obtain data related to an engine speed of the handheld power tool and to reduce the upper limit of the throttle span in case the engine speed exceeds a predetermined maximum engine speed.

11. The throttle valve arrangement according to claim 9, wherein the control unit is arranged to determine a state of the first actuator during a start-up procedure and/or during a shut-down procedure of the control unit.

12. A handheld power tool comprising a throttle valve arrangement according to claim 1.

13. A method for controlling a throttle valve arrangement of a handheld power tool, the throttle valve arrangement comprising a valve plate attached to a valve shaft, as well as a first actuator and a second actuator arranged to engage the valve shaft and jointly control the state of the valve plate, the method comprising
configuring the first actuator to limit a throttle span of the throttle valve arrangement to an upper limit between idle and wide open throttle (WOT),
configuring the second actuator to govern a state of the valve plate over the throttle span,
obtaining, by a control unit of the handheld power tool, data related to an engine speed of the handheld power tool, and
reducing the upper limit of the throttle span, by the first actuator, in response to the engine speed exceeding a desired maximum engine speed.

14. The method according to claim 13, comprising urging the state of the valve plate towards a configurable valve shaft angle between idle and WOT by the second actuator.

15. The method according to claim 13, comprising determining a state of the first actuator, by the control unit, during a start-up procedure and/or during a shut-down procedure of the control unit.

16. A handheld power tool comprising an active part driven by a two-stroke combustion engine,
the two-stroke combustion engine comprising a throttle valve arrangement arranged to regulate an air intake of the engine by control of a state of a valve plate attached to a valve shaft,
the throttle valve arrangement comprising a first actuator, and a second actuator arranged to jointly engage the valve shaft and to jointly control the state of the valve plate,
wherein the first actuator comprises an automated electrically operated actuator and the second actuator comprises a manually operated actuator.

17. The handheld power tool according to claim 16, wherein the first actuator is arranged to control an upper limit of a throttle span of the second actuator in dependence of a control signal generated by a control unit of the handheld power tool.
